(19) United States
(12) Patent Application Publication
(10) Pub. No.: US 2026/0227201 A1
(43) Pub. Date: Aug. 6, 2026

(54) APPARATUS AND METHOD FOR GENERATING A PRECISION MAP

(71) Applicants: HYUNDAI MOTOR COMPANY, Seoul (KR); KIA CORPORATION, Seoul (KR)

(72) Inventor: Yoon Bang, Hwaseong-si (KR)

(73) Assignees: HYUNDAI MOTOR COMPANY, Seoul (KR); KIA CORPORATION, Seoul (KR)

(21) Appl. No.: 19/265,853

(22) Filed: Jul. 10, 2025

(30) Foreign Application Priority Data
Feb. 5, 2025 (KR) 10-2025-0014790

(51) Int. Cl. G01C 21/00; G06V 10/26; G06V 10/44; G06V 10/62; G06V 10/82; G06V 20/56

(52) U.S. Cl. CPC G01C 21/3867; G01C 21/3833; G06V 10/26; G06V 10/44; G06V 10/62; G06V 10/82; G06V 20/588

(57) ABSTRACT

An apparatus for generating a precision map includes a communication device configured to receive a time-series image and space information that are associated with a surrounding environment of a vehicle. The apparatus also includes a memory configured to store the time-series image and the space information. The apparatus further includes a processor configured to generate a precision map based on the time-series image and the space information. The processor is configured to extract line information based on the time-series image, generate polylines based on the line information, generate the precision map for autonomous driving based on the polylines and the space information.

### CROSS-REFERENCE TO RELATED APPLICATION

This application claims the benefit of and priority to Korean Patent Application No. 10-2025-0014790, filed on Feb. 5, 2025, the entire contents of which are hereby incorporated herein by reference.

### TECHNICAL FIELD

The present disclosure relates to an apparatus and a method for generating a precision map.

### BACKGROUND

The statements in this section merely provide background information related to the present disclosure and may not constitute prior art.

Nowadays, a vehicle capable of supporting autonomous driving and autonomous parking is being developed. For autonomous driving and autonomous parking, a technology for recognizing lines with high performance and constructing a precise map is used. Precise map constructing manners commonly known include a feature-based map manner and an occupational grid map (OGM) manner. In the precision map constructing manner, a technology for increasing the accuracy of a location by using drift compensation and a localization technology for determining an actual location of a vehicle may be used as key technologies.

In this case, the feature map has the disadvantage that the localization is possible based on a special landmark. For example, it is difficult to construct a map in an environment such as a playground where features are not extracted. In contrast, in the occupational grid map (OGM), the localization is possible without a special landmark; however, because there is a need to store thousands to tens of thousands of points, the occupational grid map has the disadvantage that the amount of memory used and the amount of computation (or calculation) are large.

In addition, the two precision map constructing manners described above belong to a manner of constructing a map based on objects with high heights. Because in both of the precision map constructing manners described above it is difficult to recognize information about a ground where there is no object with a high height, the utilization of these manners is low in indoor and outdoor parking spaces where the recognition of the ground information is important.

In addition, in both of the precision map constructing manners described above it is difficult to construct a map in an environment where many dynamic objects exist. For example, the two manners described above have a limitation on the technology for distinguishing between a static object and a dynamic object. For example, the dynamic object moves simultaneously with the vehicle, thereby making it difficult to predict behavior information. For this reason, the two methods described above have the disadvantage that it is difficult to remove a noise associated with the dynamic object.

### SUMMARY

The present disclosure has been made to solve the above-mentioned problems occurring in the prior art while advantages achieved by the prior art are maintained intact.

Aspects of the present disclosure provide a precision map generating apparatus for autonomous driving, that is capable of generating a precision map in an environment where there is no landmark and an environment where there are many dynamic objects, and a method thereof.

Other aspects of the present disclosure provide a precision map generating apparatus for autonomous driving, that is capable of improving the accuracy of localization based on line information, and a method thereof.

Other aspects of the present disclosure provide a precision map generating apparatus for autonomous driving, that is capable of memorizing a precision map only by using line information such that a map is easily reused with less computation and a small memory capacity and it is effective for memory parking, and a method thereof.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, an apparatus for generating a precision map is provided. The apparatus includes a communication device configured to receive a time-series image and space information associated with a surrounding environment of a vehicle. The apparatus also includes a memory configured to store the time-series image and the space information. The apparatus additionally includes a processor configured to generate a precision map based on the time-series image and the space information. The processor is configured to extract line information based on the time-series image, generate polylines based on the line information, and generate the precision map for autonomous driving based on the polylines and the space information.

In an embodiment, the processor may be configured to preprocess the time-series image by applying a deep learning model, extract the line information by detecting a line of a road from the time-series image, generate the polylines based on the line information and generate a polyline map based on the polylines, and generate the precision map by applying the space information to the polyline map.

In an embodiment, the processor may be configured to generate a binary image by applying semantic segmentation to the time-series image.

In an embodiment, the processor may be configured to extract an edge of the line from the binary image, determine feature points of the line from the edge, determine a similarity of the feature points by computing a distance and an angle between the feature points, and classify the feature points based on the similarity of the feature points.

In an embodiment, the processor may be configured to generate the polylines by applying a Douglas-Peucker algorithm to the feature points, determine a similarity of the polylines by computing a distance and an angle between the polylines, and classify the polylines based on the similarity of the polylines.

In an embodiment, the processor may be configured to generate depth information about the time-series image by applying a mono depth estimation technique to the time-series image.

In an embodiment, the processor may be configured to remove an outlier based on lengths of the polylines and a width of the line and may correct location coordinates of the polylines distorted, based on the depth information.

In an embodiment, the processor may be configured to merge the polylines by applying a line fitting algorithm according to weights of the polylines present in overlapped areas of respective frames of the time-series image and may generate the polyline map based on the polyline.

In an embodiment, the processor may be configured to determine location coordinates and driving directions of an object and the vehicle based on the space information, match the location coordinates and the driving directions to the polyline map, and generate a time-series polyline map based on a matching result.

In an embodiment, the processor may be configured to perform drift compensation on the time-series polyline map by using a loop closing technique and may generate the precision map by mapping the object to the time-series polyline map.

According to another aspect of the present disclosure, a method for generating a precision map is provided. The precision map generating method includes receiving a time-series image and space information associated with a surrounding environment of a vehicle, storing the time-series image and the space information, and generating a precision map based on the time-series image and the space information. Generating the precision map includes extracting line information based on the time-series image, generating polylines based on the line information, and generating the precision map for autonomous driving based on the polylines and the space information.

In an embodiment, generating the precision map for the autonomous driving may include preprocessing the time-series image by applying a deep learning model, extracting the line information by detecting a line of a road from the time-series image, generating the polylines based on the line information and generating a polyline map based on the polylines, and generating the precision map by applying the space information to the polyline map.

In an embodiment, preprocessing the time-series image may include generating a binary image by applying semantic segmentation to the time-series image.

In an embodiment, extracting the line information may include extracting an edge of the line from the binary image, determining feature points of the line from the edge, determining a similarity of the feature points by computing a distance and an angle between the feature points, and classifying the feature points based on the similarity of the feature points.

In an embodiment, generating the polyline map may include generating the polylines by applying a Douglas-Peucker algorithm to the feature points, determining a similarity of the polylines by computing a distance and an angle between the polylines, and classifying the polylines based on the similarity of the polylines.

In an embodiment, preprocessing the time-series image may further include generating depth information about the time-series image by applying a mono depth estimation technique to the time-series image.

In an embodiment, generating the polyline map may further include removing an outlier based on lengths of the polylines and a width of the line, and correcting location coordinates of the polylines distorted, based on the depth information.

In an embodiment, generating the polyline map may further include merging the polylines by applying a line fitting algorithm according to weights of the polylines present in overlapped areas of respective frames of the time-series image, and generating the polyline map based on the polyline.

In an embodiment, generating the precision map may include determining location coordinates and driving directions of an object and the vehicle based on the space information, matching the location coordinates and the driving directions to the polyline map, and generating a time-series polyline map based on a matching result.

In an embodiment, generating the precision map may further include performing drift compensation on the time-series polyline map by using a loop closing technique, and generating the precision map by mapping the object to the time-series polyline map.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating a configuration of an autonomous driving vehicle system including a precision map generating apparatus according to an embodiment of the present disclosure;

FIG. 2 is a block diagram illustrating a configuration of a processor of a precision map generating apparatus according to an embodiment of the present disclosure;

FIG. 3 illustrates an example of an image preprocessing module according to an embodiment of the present disclosure;

FIG. 4 illustrates an example of a polyline generating module according to an embodiment of the present disclosure;

FIG. 5 illustrates an example of a map generating module according to an embodiment of the present disclosure;

FIG. 6 is a flowchart for describing a precision map generating method according to an embodiment of the present disclosure;

FIGS. 7 to 10 are flowcharts for describing a precision map generating method according to an embodiment of the present disclosure in detail; and

FIG. 11 is a block diagram block a computing system according to an embodiment of the present disclosure.

### DETAILED DESCRIPTION

Below, some embodiments of the present disclosure are described in detail with reference to the accompanying drawings. In adding the reference numerals to the components of each drawing, it should be noted that the identical components are designated by the identical numerals even when the components are displayed on different drawings. Further, in describing the embodiment of the present disclosure, where it was determined that a detailed description of well-known features or functions would obscure the gist of the present disclosure, the detailed description thereof has been omitted.

In describing components of embodiments of the present disclosure, the terms first, second, A, B, (a), (b), and the like may be used herein. These terms are only used to distinguish one component from another component. These terms do not limit the corresponding components irrespective of the order or priority of the corresponding components. Furthermore, unless otherwise defined, all terms including technical and scientific terms used herein have the same meaning as being generally understood by those having ordinary skill in the art to which the present disclosure pertains. Such terms as those defined in a generally used dictionary should be interpreted as having meanings equivalent to the contextual meanings in the relevant field of art, and should not be interpreted as having ideal or excessively formal meanings unless clearly defined as having such in the present application.

In the present disclosure, when a component, controller, device, element, apparatus, module, unit or the like of the present disclosure is described as having a purpose or performing an operation, function, or the like, the component, controller, device, element, apparatus, module, unit or the like should be considered herein as being “configured to” meet that purpose or to perform that operation or function. Each component, controller, device, element, apparatus, module, unit, and the like may separately embody or be included with a processor and a memory, such as a non-transitory computer readable media, as part of the apparatus.

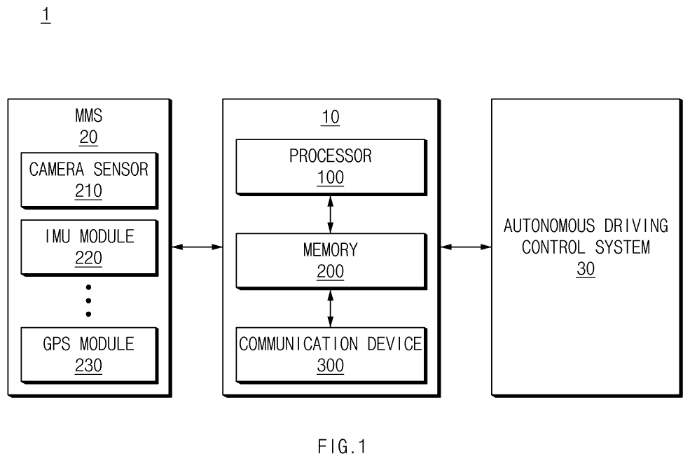

Below, embodiments of the present disclosure are described in detail with reference to FIGS. 1-11.

FIG. 1 is a block diagram illustrating a configuration of an autonomous driving vehicle system 1 including a precision map generating apparatus 10, according to an embodiment of the present disclosure.

Referring to FIG. 1, the autonomous driving vehicle system 1 may include the precision map generating apparatus 10, a mobile mapping system (MMS) 20, and an autonomous driving control system 30.

The precision map generating apparatus 10 may include a processor 100, a memory 200, and a communication device 300.

In an embodiment, the processor 100 may receive a time-series image and space information, that are associated with a surrounding environment of the vehicle, via the communication device 300. In an embodiment, the vehicle may be an autonomous vehicle including an autonomous driving device. In an embodiment, the autonomous driving device refers to a device that controls a steering and a speed of the vehicle based on information obtained by a plurality of vehicle sensors (e.g., a camera, a radar, and/or a LIDAR).

In an embodiment, the time-series image may be received from a camera sensor 210 of the MMS 20 provided in the vehicle. The time-series image may include at least one image obtained by capturing the surrounding environment of the vehicle and/or may include image frames continuous over time.

In an embodiment, the space information may be received from an IMU module 220, a GPS module 230, and a LIDAR sensor of the MMS 20. The space information may include location information of the vehicle, object information of the surrounding environment, posture information, driving information, etc.

Also, the processor 100 may extract line information based on the time-series image. In an embodiment, the line information may include a line location, a line width, etc. associated with a driving road of the vehicle.

The processor 100 may generate polylines based on the extracted line information. The polyline may mean a line which is recognized as one object in the time-series image.

The processor 100 may generate a precision map for autonomous driving based on the polylines and the space information. In an embodiment, the precision map may refer to a precision map which is used for autonomous driving and autonomous parking of the vehicle.

The processor 100 may transmit the generated precision map to the autonomous driving control system 30 via the communication device 300. The autonomous driving control system 30 may control the vehicle to perform autonomous driving based on the precision map.

In an embodiment, the processor 100 may generate a precision map of a parking lot where a parking slot of the vehicle is placed. In an example, the generated precision map may be stored in the memory 200. If the vehicle arrives at the corresponding parking lot, the processor 100 may extract the precision map from the memory 200. The processor 100 may transmit the precision map of the corresponding parking lot to the autonomous driving control system 30 via the communication device 300. According to the above description, the autonomous driving control system 30 may easily perform the autonomous parking into the parking slot of the vehicle in the corresponding parking lot.

In an embodiment, the memory 200 may store the time-series image and the space information received via the communication device 300. Also, the memory 200 may store all information processed and/or to be processed by the processor 100.

In addition, the memory 200 may include at least one memory in which a program performing the above operation or an operation to be described later is stored. In an embodiment, the memory may include a read only memory (ROM) and a random access memory (RAM).

In an embodiment, the communication device 300 may perform controller area network (CAN) communication or wired communication. For example, for the control of various kinds of control systems mounted in the vehicle and the communication between various kinds of control systems, a communication network including a body network, a multimedia network, a chassis network, etc. may be implemented in the vehicle, and the respective networks separated from each other may be interconnected by the processor 100 to transmit/receive a controller area network (CAN) communication message. The communication device 300 may transmit a variety of information to the vehicle system based on a control signal of the processor 100 and may receive a variety of information from the vehicle system.

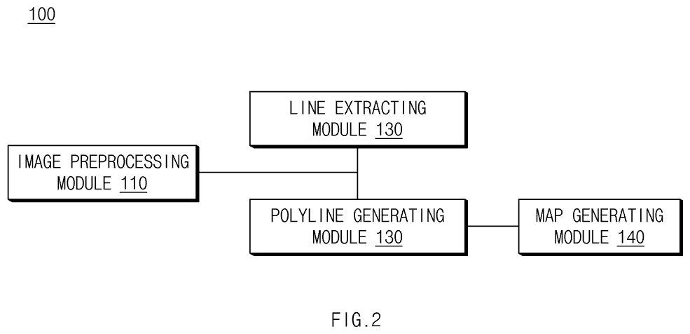

The precision map generating apparatus 10 for autonomous driving according to an embodiment of the present disclosure may be implemented within the vehicle. In this case, the precision map generating apparatus 10 may be integrally formed with control units of the vehicle; alternatively, the precision map generating apparatus 10 may be implemented with a separate device and may be connected to the control units of the vehicle by a separate connection means. The precision map generating apparatus 10, according to embodiments, is described in more detail below with reference to FIGS. 2-10.

In an embodiment, the MMS 20 may include the camera sensor 210, the IMU module 220, the GPS module 230, and the LIDAR sensor. The MMS 20 may be a system that is implemented by integrating various sensors described above and makes it possible to measure a location of a geographic feature around a driving road together with driving information of the vehicle and to obtain visual information.

In an embodiment, the camera sensor 210 may include a multi-channel wide-angle lens and may collect a time-series image. For example, the camera sensor 210 may be a 4-channel wide-angle camera capturing (or recording) front, rear, left, and right environments of the vehicle and may collect a time-series RGB image. However, this is provided only as an example, and the present disclosure is not limited thereto. Also, the camera sensor 210 may include at least one or more cameras.

In an embodiment, the IMU module 220 and the GPS module 230 may collect the space information of the vehicle. For example, the IMU module 220 and the GPS module 230 may collect location information, posture information, driving information, etc. of the vehicle. Also, the LIDAR sensor may collect object information of the surrounding environment. In an embodiment, the object information may include a static object such as a street light and a dynamic object such as a person or a vehicle.

In an embodiment, the autonomous driving control system 30 may be a system that controls the autonomous driving and autonomous parking of the vehicle. For example, the autonomous driving control system 30 may receive a precision map of a specific area from the processor 100. The autonomous driving control system 30 may perform the autonomous driving and autonomous parking in the specific area based on the precision map.

As described above, the precision map generating apparatus 10 for autonomous driving according to the present disclosure may improve the performance of autonomous driving and autonomous parking of the vehicle by recognizing lines (e.g., a driving line, a parking line, a stop line, and any other road marker) present in the driving environment of the vehicle and extracting information of the lines.

FIG. 2 is a block diagram illustrating a configuration of the processor 100 of the precision map generating apparatus 10, according to an embodiment of the present disclosure.

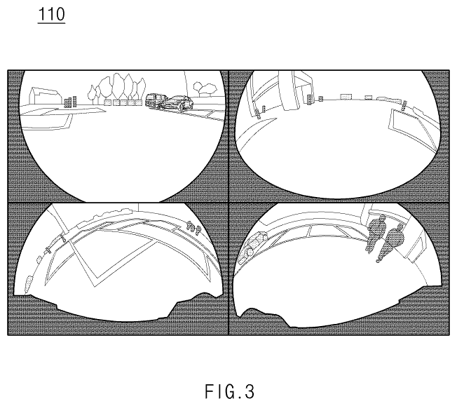

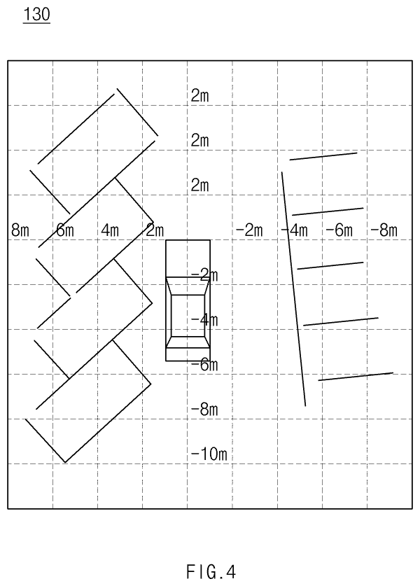

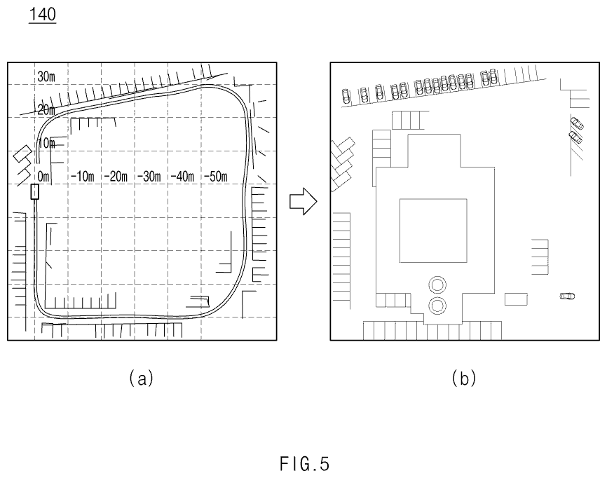

FIG. 3 illustrates an example of an image preprocessing module 110, according to an embodiment of the present disclosure. FIG. 4 illustrates an example of a polyline generating module 130, according to an embodiment of the present disclosure. FIG. 5 illustrates an example of a map generating module 140, according to an embodiment of the present disclosure.

Referring to FIG. 2, the processor 100 may include the image preprocessing module 110, a line extracting module 120, the polyline generating module 130, and the map generating module 140.

In an embodiment, the image preprocessing module 110 may preprocess a time-series image by applying a deep learning model. In an example, the deep learning model may be a semantic segmentation model, but the present disclosure is not limited thereto. For example, referring to FIG. 3, the image preprocessing module 110 may receive a time-series image from the 4-channel wide-angle camera and may apply semantic segmentation to the received time-series image. According to the above description, the image preprocessing module 110 may classify the time-series image as a specific class based on pixel information. In this case, the image preprocessing module 110 may select the specific class as a line. The image preprocessing module 110 may set the line to the specific class to generate a binary image. In an embodiment, the line may include a driving line, a parking line, a stop line, any other road marker, etc. In the specific class, a driving line, a parking line, a stop line, any other road marker, etc. may be set to a detailed class.

As described above, the precision map generating apparatus 10 according to an embodiment of the present disclosure may set information of all the lines in the vehicle surrounding environment to the specific class and may then assign a specialty to a precision map to be generated. Further, the precision map generating apparatus 10 according to an embodiment of the present disclosure may easily correct the localization of the vehicle.

In an embodiment, the image preprocessing module 110 may apply a mono depth estimation technique to the time-series image to generate depth information about the time-series image. The image preprocessing module 110 may transmit the depth information to the polyline generating module 130.

Returning to FIG. 2, the line extracting module 120 may detect a line of a road from the preprocessed time-series image and may extract line information.

In an embodiment, the line extracting module 120 may receive the binary image from the image preprocessing module 110 and may extract an edge(s) of the line from the binary image. Afterwards, the line extracting module 120 may calculate or otherwise determine feature points of the line from the extracted edge(s). In an embodiment, the feature point may be a feature point associated with a vertical direction, but the present disclosure is not limited thereto. The line extracting module 120 may calculate or otherwise determine a similarity of the feature points by computing a distance and an angle between the extracted feature points. In an embodiment, the similarity may be a similar degree associated with the distance and the angle between the feature points. The line extracting module 120 may classify the feature points based on the determined similarity of the feature points. For example, the line extracting module 120 may include feature points with a high similarity in one group, e.g., may perform clustering on the feature points. In more detail, feature points which satisfy two conditions below may be clustered in the same group.
1. distPoint(Pₙ₋₁, Pₙ)<maxDistThr1 (herein, Pₙ being a coordinate value (x, y) of an n-th feature point, and distPoint( ) being a distance between two points)
2. anyLine(P̅ₙ̅₋̅₂̅P̅ₙ̅₋̅₁̅, P̅ₙ̅₋̅₁̅P̅ₙ̅)<maxAngtThr1 (herein, (Pₙ̅₋̅₂̅P̅ₙ̅₋̅₁̅ being a line segment connecting Pₙ₋₁ and Pₙ, and anyLine( ) being an angle which two line segments form)

The line extracting module 120 may assign an index for a group, to which a feature point belongs, to the feature point. Also, the line extracting module 120 may define a start feature point and the last feature point in one group.

As described above, a line being a feature point is capable of being expressed by two points. According to the above description, even though a lot of line information is stored, the precision map generating apparatus 10 according to embodiments of the present disclosure may reduce the amount of memory used and a computation processing time compared to a conventional technology.

In an embodiment, the polyline generating module 130 may generate polylines based on the line information. For example, the polyline generating module 130 may generate polylines by applying a Douglas-Peucker algorithm to the classified feature points. Herein, the Douglas-Peucker algorithm is an algorithm which simplifies a curved line (or a polygon) formed of line components. The polyline generating module 130 may calculate or otherwise determine a similarity of the polylines by computing a distance and an angle between the generated polylines. In an embodiment, the similarity may be a similar degree associated with the distance and the angle between the polylines. The polyline generating module 130 may classify the polylines based on the determined similarity of the polylines. For example, the polyline generating module 130 may incorporate polylines with a high similarity into one group, e.g., may perform clustering on the polylines. In more detail, polylines which satisfy two conditions below may be clustered in the same group.
1. distPoint(PL_{m-1,e}, PL_{m,s})<maxDistThr2 (herein, PL_{m-1,e} being a coordinate value of a first polyline, and PL_{m,s} being a coordinate value of an m-th polyline)
2. anyLine(P̅L̅_̅{̅m̅-̅1̅,̅s̅}̅P̅L̅_̅{̅m̅-̅1̅,̅ε̅}̅, P̅L̅_̅{̅m̅,̅s̅}̅P̅L̅_̅{̅m̅,̅ε̅}̅)<maxAngtThr2 (herein, P̅L̅_̅{̅m̅,̅s̅}̅P̅L̅_̅{̅m̅,̅ε̅}̅ being a line segment connecting a start point and an end point of the m-th polyline, maxDistThr1<<maxDistThr2, and maxAngtThr1<<maxAngtThr2)

In an embodiment, the polyline generating module 130 may remove an outlier between a length of a polyline and a line width. For example, the polyline generating module 130 may remove the outlier based on a polyline of 2 m or more and a line width of 15 to 20 cm. However, this is provided only as an example, and the present disclosure is not limited thereto.

Referring to FIG. 4, the polyline generating module 130 may generate a polyline map based on the generated polylines.

In an embodiment, the polyline generating module 130 may correct location coordinates of a distorted polyline based on depth information. For example, the polyline generating module 130 may receive the depth information about the time-series image from the image preprocessing module 110. A location of a polyline may be distorted by a gradient, and the polyline generating module 130 may correct location coordinates of the distorted polyline based on the received depth information. In an embodiment, the location coordinates may be based on the world coordinate system, but the present disclosure is not limited thereto. In more detail, the location coordinates of the polyline may be corrected by using the following equation.

I2W(Iₙ, Dₙ)=Pₙ, where W2I(Pₙ)=Iₙ, where Iₙ is an image coordinate system value corresponding to Pₙ, Pₙ is a world coordinate system value of corrected Pₙ, I2W/W2I is a coordinate system transformation function, and Dₙ is a depth value corresponding to Iₙ.

As described above, precision maps of various environments, for example, a precision map of a space such as a parking lot may be generated by correcting location information about a line based on depth information of an image.

In an embodiment, the polyline generating module 130 may extract polylines present in overlapped areas of respective frames of a time-series image. For example, a 4-channel time-series image may be an image obtained by capturing front, rear, left, and right surroundings of the vehicle, and an overlapped area may be present in each time-series image frame. Accordingly, the polyline generating module 130 may apply a line fitting algorithm being an image processing technique depending on a weight of a polyline present in the overlapped area. According to the above process, the polyline generating module 130 may merge overlapping polylines to one polyline. The polyline generating module 130 may generate the polyline map based on the merged polyline.

Returning to FIG. 2, the map generating module 140 may apply the space information to the polyline map to generate a precision map.

In an embodiment, the map generating module 140 may calculate or otherwise determine location coordinates and driving directions of the vehicle and the object based on the space information. For example, the map generating module 140 may calculate or otherwise determine location coordinates, a driving direction, a speed, etc. of the vehicle. The map generating module 140 may match the determined location coordinates and driving direction of the vehicle to the polyline map. In an embodiment, because the polyline map is generated from the time-series image including frames continuous over time, the polyline map may also include frames continuous over time. For example, the map generating module 140 may compute a parallel movement, a rotation, etc. between the continuous frames of the polyline map. The map generating module 140 may follow the movement of the vehicle based on a result of the computation. For example, the map generating module 140 may match the location coordinates and driving direction of the vehicle to the polyline map in which the movement of the vehicle is followed, in a one-to-one correspondence.

Referring to (a) of FIG. 5, according to the above process, the map generating module 140 may generate a time-series polyline map based on a matching result.

Also, if the vehicle revisits a specific area whose precision map is previously generated and stored, the map generating module 140 may generate the polyline map in real time. The map generating module 140 may thus precisely determine a location of the vehicle by matching the polyline map being generated in real time to the stored precision map.

In an embodiment, the map generating module 140 may perform drift compensation on the time-series polyline map by using a loop closing technique. In an example, the drift may mean a phenomenon that an error of a map increases over time due to accumulation of the error of the map. For example, the drift may occur as an error associated with the estimation of the movement of the vehicle and an error due to a gradient are accumulated. The correction of the localization of the vehicle is required to generate a precision map, and the drift compensation should be performed to correct the localization of the vehicle. Also, the loop closing technique is called loop closure detection and is a technique which is used for the drift compensation by the location estimation.

For example, the map generating module 140 may set a time-series polyline map for a start time point of the precision map to a QR map. In other words, the precision map generating apparatus 10 according to the present disclosure may generate a precision map of a specific area. The start time point of the precision map may include a start time point at which the vehicle enters the specific area, but the present disclosure is not limited thereto. The map generating module 140 may perform drift compensation by applying the loop closing technique to the set QR map. In an example, it is assumed that the vehicle currently revisits the specific area whose precision map is previously generated and stored. The map generating module 140 may perform drift compensation by calculating or otherwise determining a relative location of the QR map and a current polyline map of the vehicle by using an iterative closest point (ICP) technique. Accordingly, the map generating module 140 may precisely correct an entire route of the vehicle for the specific area.

As described above, the accuracy of drift compensation using the loop closing technique may be improved by performing location correction on the line information based on depth information of an image.

Referring to (b) of FIG. 5, the map generating module 140 may map an object to the time-series polyline map to generate a precision map. In an embodiment, the object that is a static object may include a stopper, a curb, a pillar, a traffic cones, a tree, etc. For example, the map generating module 140 may map a static object to the time-series polyline map and may perform mapping on the relative location of the polyline. Accordingly, the map generating module 140 may correct a route such that the accuracy is improved.

The map generating module 140 may assign the specialty to the precision map by mapping a static object commonly seen in a parking lot. In other words, the precision map generating apparatus 10 may easily generate a precision map for a parking lot. In addition, the precision map generating apparatus 10 may improve the specialty of the precision map by setting the static object as well as the line to the specific class.

As described above, the precision map generating apparatus 10 for autonomous driving according to embodiments of the present disclosure may improve the accuracy of drift compensation and localization, and thus, the reliability of the precision map be improved. For example, the precision map generating apparatus 10 may generate the precision map only by using ground information even in an environment where it is difficult to detect a feature point by a landmark or an environment where there are many dynamic objects.

Also, the precision map generating apparatus 10 may generate the precision map by using only the line information, and thus, the amount of memory used and a computation processing time may decrease. This may mean that the efficiency of computation may be improved. In addition, the precision map generating apparatus 10 may provide the precision map with high accuracy, and thus, the reliability of autonomous driving and autonomous parking of the vehicle may be improved.

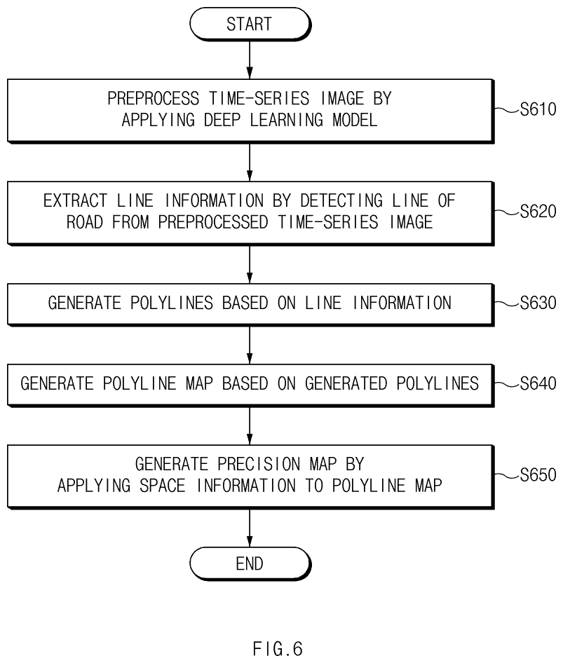

Below, a precision map generating method for autonomous driving according to an embodiment of the present disclosure is described in more detail with reference to FIGS. 6-10.

Below, it is assumed that the precision map generating apparatus 10 of FIG. 2 performs the process of FIGS. 6-10. Also, in the description to be given with reference to FIGS. 6-10, an operation described as being performed by a device may be understood as being controlled by the processor 100 of the precision map generating apparatus 10.

FIG. 6 is a flowchart for describing a precision map generating method, according to an embodiment of the present disclosure.

Referring to FIG. 6, in an operation S610, a time-series image may be preprocessed by applying a deep learning model. Herein, the deep learning model may be a semantic segmentation model, but the present disclosure is not limited thereto.

In an operation S620, line information may be extracted by detecting a line(s) of a road from the preprocessed time-series image. In an embodiment, the line may include a driving line, a parking line, a stop line, any other road marker, etc.

In an operation S630, polylines may be generated based on the line information. For example, the polylines may be generated by applying the Douglas-Peucker algorithm to the line information.

In an operation S640, a polyline map may be generated based on the generated polylines.

In an operation S650, a precision map may be generated by applying space information to the polyline map. For example, location coordinates and a driving direction of a vehicle may be matched to the polyline map, and an object may be mapped to the polyline map. The precision map may be generated as a matching result.

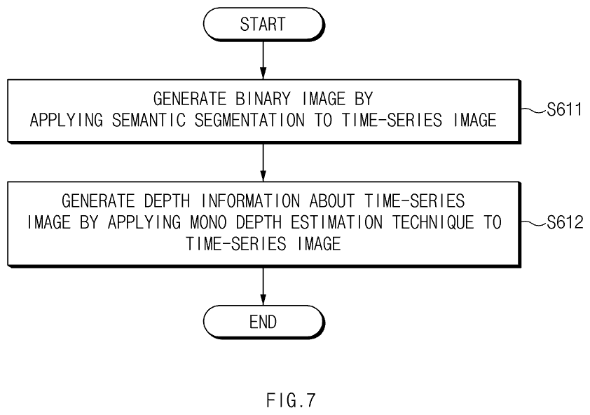

FIGS. 7-10 are flowcharts for describing a precision map generating method, according to an embodiment of the present disclosure, in detail.

A precision map generating method of FIG. 7 may be performed by the image preprocessing module 110 of FIG. 2.

Referring to FIG. 7, in an operation S611, a binary image may be generated by applying semantic segmentation to a time-series image. For example, a binary image in which a line is set to a specific class may be generated.

In an operation S612, depth information about the time-series image may be generated by applying the mono depth estimation technique to the time-series image. The depth information may then be used to correct a location of a polyline.

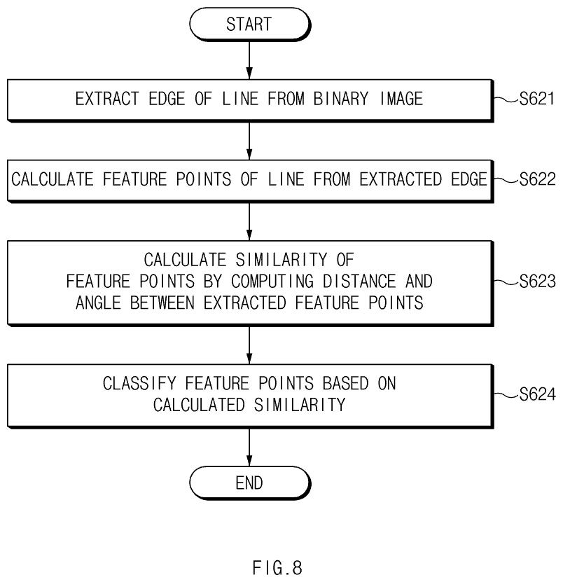

A precision map generating method of FIG. 8 may be performed by the line extracting module 120 of FIG. 2.

Referring to FIG. 8, in an operation S621, an edge of the line may be extracted from the binary image.

In an operation S622, feature points of the line may be calculated or otherwise determined from the extracted edge.

In an operation S623, a similarity of the feature points may be determined by computing a distance and an angle between the extracted feature points. Herein, the similarity may be a similar degree associated with the distance and the angle between the feature points.

In an operation S624, the feature points may be classified based on the determined similarity of the feature points. In an embodiment, an index for a group to which a feature point belongs may be assigned to the feature point.

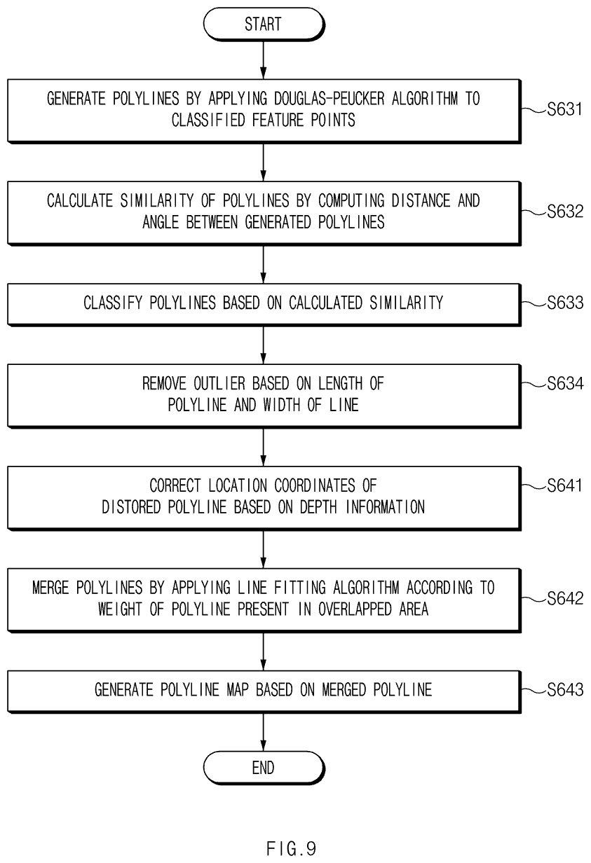

A precision map generating method of FIG. 9 may be performed by the polyline generating module 130 of FIG. 2.

Referring to FIG. 9, in an operation S631, polylines may be generated by applying the Douglas-Peucker algorithm to the classified feature points.

In an operation S632, a similarity of the polylines may be determined by computing a distance and an angle between the generated polylines. In an embodiment, the similarity may be a similar degree associated with the distance and the angle between the polylines.

In an operation S633, the polylines may be classified based on the determined similarity of the polylines. Polylines with high similarity may be included in one group, e.g., clustering on the polylines may be performed.

In an operation S634, an outlier may be removed based on a length of a polyline and a width of a line. For example, the outlier may be removed based on a polyline of 2 meters (m) or more and a line width of 15 to 20 centimeters (cm). However, this is provided only as an example, and the present disclosure is not limited thereto.

In an operation S641, location coordinates of a distorted polyline may be corrected based on depth information. For example, a location of a polyline may be distorted by a gradient, and location coordinates of the distorted polyline may be corrected based on the received depth information.

In an operation S642, the polylines may be merged by applying the line fitting algorithm according to a weight to a polyline present in an overlapped area. That is, polylines overlapping in the time-series image may be merged to one polyline.

In an operation S643, a polyline map may be generated based on the merged polyline.

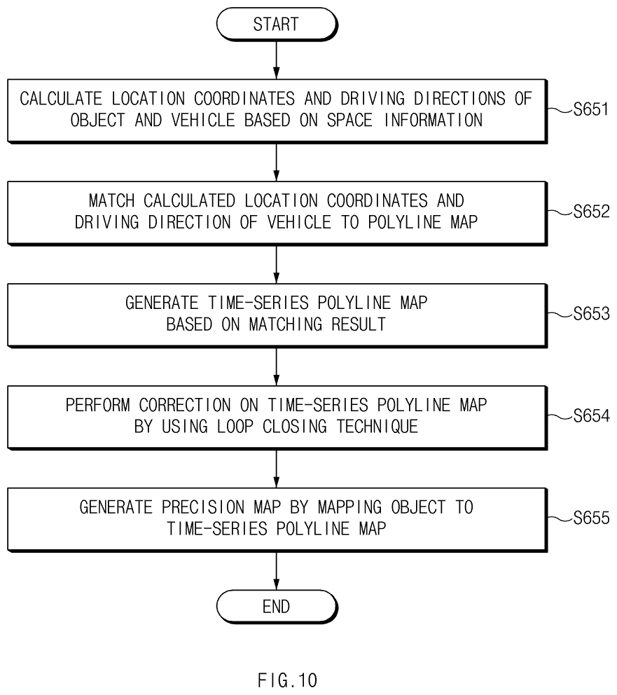

A precision map generating method of FIG. 10 may be performed by the map generating module 140 of FIG. 2.

Referring to FIG. 10, in an operation S651, location coordinates and driving directions of a vehicle and an object may be calculated or otherwise determined based on the space information. For example, location coordinates, a driving direction, a speed, etc. of the vehicle may be calculated or otherwise determined. Also, a stopper, a curb, a pillar, a traffic cone, a tree, etc. may be detected as a static object.

In an operation S652, the determined location coordinates and driving direction of the vehicle may be matched to a polyline map.

In an operation S653, a time-series polyline map may be generated based on a matching result.

In an operation S654, drift compensation on the time-series polyline map may be performed by using the loop closing technique. According to the above description, an entire route of the vehicle associated with the specific area may be precisely corrected.

In an operation S655, a precision map may be generated by mapping the object to the time-series polyline map.

As described above, a precision map generating method for autonomous driving according to embodiments of the present disclosure may improve the accuracy of drift compensation and localization, and thus, the reliability of the precision map be improved. Also, the precision map generating method according to embodiments of the present disclosure may generate the precision map only by using the line information, and thus, the amount of memory used and a computation processing time may decrease. This may mean that the efficiency of computation may be improved. In addition, the precision map generating method according to embodiments of the present disclosure may provide the precision map with high accuracy, and thus, the reliability of autonomous driving and autonomous parking of the vehicle may be improved.

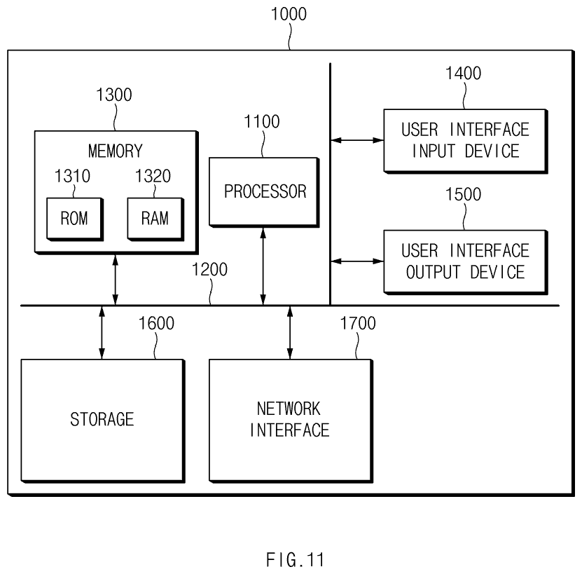

FIG. 11 is a block diagram illustrating a computing system 1000, according to an embodiment of the present disclosure.

Referring to FIG. 11, the computing system 1000 may include at least one processor 1100, a memory 1300, a user interface input device 1400, a user interface output device 1500, storage 1600, and a network interface 1700, which are connected via a bus 1200.

The processor 1100 may be a central processing unit (CPU) or a semiconductor device which processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described based on the embodiments disclosed in the specification may be directly implemented with a hardware module, a software module, or a combination of the hardware module and the software module, which is executed by the processor 1100. The software module may reside on a storage medium (e.g., the memory 1300 and/or the storage 1600) such as a RAM, a flash memory, a ROM, an EPROM, an EEPROM, a register, a hard disk, a removable disk, and a CD-ROM.

The example storage medium may be coupled to the processor 1100. The processor 1100 may read information from the storage medium and may write information in the storage medium. As another method, the storage medium may be integrated with the processor 1100. The processor 1100 and the storage medium may reside in an application specific integrated circuit (ASIC). The ASIC may reside in a user terminal. As another method, the processor 1100 and the storage medium may reside in the user terminal as separate components.

The user interface input device 1400 may include an input device which receives a user input.

The user interface output device 1500 may include a display which displays various types of information associated with the driving and/or the functions of the vehicle, and a speaker which outputs various sounds associated with the driving and/or the functions of the vehicle.

In an embodiment, the display may provide a user interface for interaction between passengers and the vehicle. For example, the display may include a liquid crystal display (LCD) panel and/or a light emitting diode (LED).

The display may provide various types of information to the user based on a control signal of the processor 1100. For example, the display may be provided in a center fascia being a central area of a dashboard inside the vehicle, and a display device may be a component of a head unit or may be a component of a navigation device provided separately from the head unit. Herein, the head unit may process and output an audio signal and a video signal and may also be capable of performing a navigation function. Accordingly, the head unit is also referred to as an “audio video navigation (AVN) device”. For example, the display may display a route guide screen, e.g., a screen necessary to perform the navigation function. For example, the display may further display a screen necessary to perform an audio function, a video function, or a dialing function.

The network interface 1700 may include a long-distance communication module and/or a short-range communication module which transmits/receives data to and from an external device (e.g., a server or a user terminal). For example, the network interface 1700 may refer to a communication module capable of performing wireless Internet communication such as wireless LAN (WLAN), wireless broadband (WiBro), Wi-Fi, world interoperability for microwave access (Wimax), and high speed downlink packet access (HSDPA).

For example, the user may input a destination by using the user interface input device 1400, and the user interface output device 1500 may provide a route to reach the destination.

Embodiments of the present disclosure may improve the reliability of a precision map by improving the accuracy of drift compensation and localization.

Also, embodiments of the present disclosure may generate the precision map only by using line information, and thus, the amount of memory used and a computation processing time may decrease. This may mean that the efficiency of computation may be improved.

In addition, embodiments of the present disclosure may provide the precision map with high accuracy, and thus, the reliability of autonomous driving and autonomous parking of a vehicle may be improved.

Furthermore, embodiments of the present disclosure may memorize the precision map only by using the line information; in this case, a map may be easily reused with less computation and a small memory capacity, and it may be effective for memory parking.

Hereinabove, although the present disclosure has been described with reference to example embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. An apparatus for generating a precision map, the apparatus comprising:
a communication device configured to receive a time-series image and space information, that are associated with a surrounding environment of a vehicle;
a memory configured to store the time-series image and the space information; and
a processor configured to generate a precision map based on the time-series image and the space information,
wherein the processor is configured to:
extract line information based on the time-series image,
generate polylines based on the line information, and
generate the precision map for autonomous driving based on the polylines and the space information.

2. The apparatus of claim 1, wherein the processor is configured to:
preprocess the time-series image by applying a deep learning model;
extract the line information by detecting a line of a road from the time-series image;
generate the polylines based on the line information and to generate a polyline map based on the polylines; and
generate the precision map by applying the space information to the polyline map.

3. The apparatus of claim 2, wherein the processor is configured to generate a binary image by applying semantic segmentation to the time-series image.

4. The apparatus of claim 3, wherein the processor is configured to:
extract an edge of the line from the binary image;
determine feature points of the line from the edge;
determine a similarity of the feature points by computing a distance and an angle between the feature points; and
classify the feature points based on the similarity of the feature points.

5. The apparatus of claim 4, wherein the processor is configured to:
generate the polylines by applying a Douglas-Peucker algorithm to the feature points;
determine a similarity of the polylines by computing a distance and an angle between the polylines; and
classify the polylines based on the similarity of the polylines.

6. The apparatus of claim 5, wherein the processor is configured to generate depth information about the time-series image by applying a mono depth estimation technique to the time-series image.

7. The apparatus of claim 6, wherein the processor is configured to:
remove an outlier based on lengths of the polylines and a width of the line; and
correct location coordinates of the polylines distorted, based on the depth information.

8. The apparatus of claim 7, wherein the processor is configured to:
merge the polylines by applying a line fitting algorithm according to weights of the polylines present in overlapped areas of respective frames of the time-series image; and
generate the polyline map based on the polyline.

9. The apparatus of claim 8, wherein the processor is configured to:
determine location coordinates and driving directions of an object and the vehicle based on the space information;
match the location coordinates and the driving directions to the polyline map; and
generate a time-series polyline map based on a matching result.

10. The apparatus of claim 9, wherein the processor is configured to:
perform drift compensation on the time-series polyline map by using a loop closing technique; and
generate the precision map by mapping the object to the time-series polyline map.

11. A method for generating a precision map, the method comprising:
receiving a time-series image and space information, which are associated with a surrounding environment of a vehicle;
storing the time-series image and the space information; and
generating a precision map based on the time-series image and the space information,
wherein generating the precision map includes:
extracting line information based on the time-series image,
generating polylines based on the line information, and
generating the precision map for autonomous driving based on the polylines and the space information.

12. The method of claim 11, wherein generating the precision map for the autonomous driving includes:
preprocessing the time-series image by applying a deep learning model;
extracting the line information by detecting a line of a road from the time-series image;
generating the polylines based on the line information and generating a polyline map based on the polylines; and
generating the precision map by applying the space information to the polyline map.

13. The method of claim 12, wherein preprocessing the time-series image includes generating a binary image by applying semantic segmentation to the time-series image.

14. The method of claim 13, wherein extracting the line information includes:
extracting an edge of the line from the binary image;
determining feature points of the line from the edge;
determining a similarity of the feature points by computing a distance and an angle between the feature points; and
classifying the feature points based on the similarity of the feature points.

15. The method of claim 14, wherein generating the polyline map includes:
generating the polylines by applying a Douglas-Peucker algorithm to the feature points;
determining a similarity of the polylines by computing a distance and an angle between the polylines; and
classifying the polylines based on the similarity of the polylines.

16. The method of claim 15, wherein preprocessing the time-series image further includes generating depth information about the time-series image by applying a mono depth estimation technique to the time-series image.

17. The method of claim 16, wherein generating the polyline map further includes:
removing an outlier based on lengths of the polylines and a width of the line; and
correcting location coordinates of the polylines distorted, based on the depth information.

18. The method of claim 17, wherein generating the polyline map further includes:
merging the polylines by applying a line fitting algorithm according to weights of the polylines present in overlapped areas of respective frames of the time-series image; and
generating the polyline map based on the polyline.

19. The method of claim 18, wherein generating the precision map includes:
determining location coordinates and driving directions of an object and the vehicle based on the space information;
matching the location coordinates and the driving directions to the polyline map; and
generating a time-series polyline map based on a matching result.

20. The method of claim 19, wherein generating the precision map further includes:
performing drift compensation on the time-series polyline map by using a loop closing technique; and
generating the precision map by mapping the object to the time-series polyline map.
